(19) United States
(12) Patent Application Publication
(10) Pub. No.: US 2010/0309185 A1
(43) Pub. Date: Dec. 9, 2010

(54) LOW-POWER AND LIGHTWEIGHT HIGH-RESOLUTION DISPLAY

(76) Inventors: Robert D. Koester, Mogadore, OH (US); Eric R. Franchino, Stow, OH (US); Robert A. Gebben, North Canton, OH (US); Todd J. Spencer, Hartville, OH (US); Terry L. Yakupcak, Uniontown, OH (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/478,814

(22) Filed: Jun. 5, 2009

(51) Int. Cl. G09G 5/00; G09G 3/32

(52) U.S. Cl. 345/211; 345/82; 345/1.3

(57) ABSTRACT

A low-power and lightweight display mountable on a support structure, such as an airship, includes a plurality of display modules configured in a M-row×N-column array. Each display module includes a control panel and a pair of associated display panels that are flexibly interconnected. Each of the control and display panels carries a plurality of LED pixels, which are configured to communicate with a video processing system. The processing system captures an image from an input source and processes it to form a scrambled bit stream that matches the configuration of the pixels carried by the display modules to render a complete video image.

### TECHNICAL FIELD

Generally, the present invention relates to video displays. Particularly, the present invention relates to low-power, lightweight video displays that are capable of displaying high-resolution images in outdoor environments and upon moving vehicles, such as an airship. More particularly, the present invention relates to low-power, lightweight video displays that utilize distributed processing to render high-resolution video images.

### BACKGROUND ART

Currently, there is a trend of utilizing large-scale LED (light emitting diodes) displays to present moving images outdoors, such as at concerts, and live sporting events for example. Unfortunately, however, such large-scale displays are limited in their use due to their weight, cost of transporting the display to various venues, and their high maintenance costs. However, in spite of these drawbacks, such large-scale displays continue to be very popular and are in strong demand.

In particular, large-scale LED displays have been carried upon lighter-than-air vehicles, such as airships, to present moving images at altitude. As such, the altitude of the airship combined with the colorful and dynamic LED display carried thereby creates a dramatic spectacle which effectively captures the attention of observers. However, the size and pixel density of the display forms a significant amount of the payload of the airship and impairs the ability of the airship to navigate in a safe manner. As such, constraints on the size and weight of the display that may be carried by the airship have been imposed to ensure that the airship remains safely buoyant and controllable.

Existing large-scale LED display designs used by airships comprise a matrix of pixels formed from red, green, and blue (RGB) LEDs that are used during the night to render full-color images, and pixels formed from orange LEDs to display mono-color images during the day. Every pixel type, including those formed from RGB LEDs and orange LEDs, requires its own specific driving circuit board that is configured to provide a data signal to select the intensity level for the associated LED, and a power signal to illuminate each associated LED. In particular, each pixel driving circuit is limited in its use of electrical current by summing circuitry that drives various diodes to the appropriate intensity. Because these pixel driving circuit boards operate in harsh environmental conditions, such as wind, rain, snow, and UV radiation, the failure rate of the driving circuit boards is generally high. And due to the nature and complexity of the circuitry maintained by the pixel driving circuit boards, repairs are generally time consuming and costly.

Furthermore, due to the limitations of current designs, such large-scale displays are only capable of generating video images with a frame rate of a maximum of 24 frames per second, which results in video images that are choppy and distorted. And due to the image processing limitations of such large-scale displays, they are prevented from presenting images from live video feeds.

In addition, existing large-scale LED displays consume a significant amount of power from the limited power capacity that is available from the onboard generators aboard of the airship. As such, current large-scale displays must be appropriately sized to be compatible with the available power capacity of the airship, which restricts the use of current displays to those particular airships that have been retrofitted with specialized power generation equipment that allows the operation of such large-scale LED displays.

Therefore, there is a need for a high-resolution LED display that is lightweight and is readily transportable. In addition, there is a need for a high-resolution LED display that is capable of rendering live video at least at 30 frames per second. Moreover, there is a need for a high-resolution LED display that utilizes a reduced amount of power, and that is capable of being flexibly mounted and carried by an airship or upon any suitable structure.

### SUMMARY OF INVENTION

In light of the foregoing, it is a first aspect of the present invention to provide a low-power and lightweight high-resolution display.

It is another aspect of the present invention to provide a display module for a display comprising a control panel, a pair of display panels comprising a honeycomb layer, wherein the control panel and the display panels carry a plurality of illuminable pixels, and a communication link flexibly coupling the control panel to the pixels maintained by the display panels wherein the plurality of illuminable pixels are controlled by the control panel.

Yet another aspect of the present invention is a display to render a video image comprising a M-row by N-column array of display modules maintaining a plurality of illuminable pixels, wherein the array is divided into at least a first section and a second section, a power bus having at least two power grids, such that one of the grids is coupled to the first section, and another of the grids is coupled to a second section, so as to provide independent power signals thereto, and a video processing system coupled to each the N-column of the array, the video processing system receiving a video input data signal containing intensity values associated with each pixel from a video input source coupled thereto, wherein the video processing system adjusts the intensity values based on the magnitude of the power signal supplied by the power source.

Still another aspect of the present invention is a display to render a video image comprising a M-row by N-column array of display modules maintaining a plurality of illuminable pixels, wherein the array is divided into at least a first section and a second section, wherein the display modules comprise a control panel that is flexibly and electrically coupled to a pair of display panels that include a honeycomb layer of open cell columns, such that the pixels carried by each the panel is controlled by the control panel, a power bus coupled to the display modules to provide a power signal thereto, and a video processing system coupled to each control panel of the array, the video processing system receiving a video input data signal containing intensity values associated with each pixel from a video input source coupled thereto, wherein the video processing system adjusts the intensity values based on the magnitude of the power signal supplied by the power bus, the adjusted intensity values used by the control panels to control the illumination of the pixels.

Yet another aspect of the present invention is a display to render a video image comprising a M-row by N-column array of display modules maintaining a plurality of illuminable pixels, wherein the array is divided into at least a first section and a second section, wherein the display modules comprise a control panel that is flexibly and electrically coupled to a pair of display panels that include a honeycomb layer of open cell columns, such that the pixels carried by each panel is controlled by the control panel, a power bus having at least two power grids, such that one of the grids is coupled to the first section, and another of the grids is coupled to a second section, so as to provide independent power signals thereto, and a video processing system coupled to the array via a driver interface, the video processing system adapted to receive a video input data signal containing intensity values associated with each pixel from a video input source, wherein the video processing system converts the video input data signal into a data word that is addressed according to the M-rows and N-columns of the array, the video processing system comprising a first and a second buffer memory that are coupled to the driver interface that converts the data word into a serial data interface signal to control the illumination of the pixels maintained by each display module, such that the video processing system loads the data word into the first buffer memory when the second buffer memory is loading another data word into the driver interface, and loads the data word into the second buffer memory when the first buffer memory is loading another data word into the driver interface.

### BRIEF DESCRIPTION OF THE DRAWINGS

These and other features and advantages of the present invention will become better understood with regard to the following description, appended claims, and accompanying drawings wherein:

FIG. 1 is a schematic view of a low-power, high-resolution display system configured to be carried aboard an airship in accordance with the concepts of the present invention;

FIGS. 2A and 2B are block diagrams showing the components of a video processing system and a display maintained by the display system in accordance with the concepts of the present invention;

FIGS. 3A and 3B are schematic views of a plurality of display modules that form the high-resolution display in accordance with the concepts of the present invention;

FIG. 4 is a top plan view of the display module in accordance with the concepts of the present invention;

FIG. 5A is a perspective view of sandwich board material used to from display panels maintained by the display modules in accordance with the concepts of the present invention;

FIG. 5B is a cross-sectional view of the sandwich board used to form the display panels as taken along lines 5B-5B in FIG. 5A in accordance with the concepts of the present invention;

FIG. 6 is a perspective view of a plurality standoffs used to attach the display modules to the envelope of the airship in accordance with the concepts of the present invention;

FIG. 7 is a schematic view of a video processing system maintained by the high-resolution display system in accordance with the concepts of the present invention;

FIG. 8 is a flow diagram showing the process steps for converting an image to a data signal that is compatible for receipt by the display in accordance with the concepts of the present invention;

FIGS. 9A and 9B are schematic views of a portion of a plurality of interconnected display modules that are configured as horizontal and vertical shift registers in accordance with the concepts of the present invention;

FIG. 10 is a schematic view of a control unit maintained by the control panel used to control the illumination of the pixels in accordance with the concepts of the present invention; and

FIG. 11 is a schematic diagram of a pixel drive control maintained by the control unit in accordance with the concepts of the present invention.

### BEST MODE FOR CARRYING OUT THE INVENTION

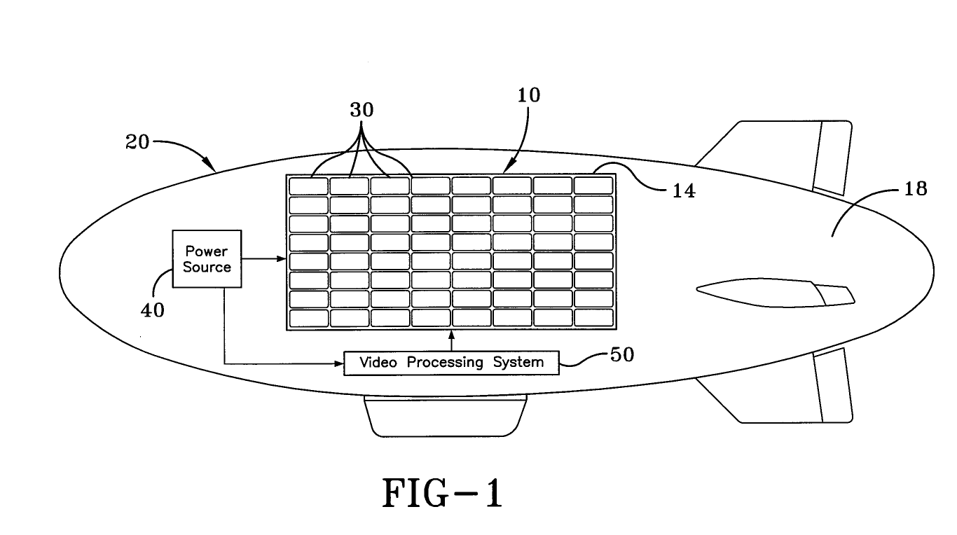

A high-resolution display system is generally referred to by the numeral 10, as shown in FIG. 1 of the drawings. The display system 10 includes a high-resolution display 14 that maintains a plurality of pixels formed of red, green, and blue LEDs (light emitting diodes), which is configured to present still or moving video images at high-resolution, hereinafter referred to by the term “video image.” The display 14 is attached to the outer surface of an envelope 18 of an airship 20, although the display system 10 may be carried or supported by any suitable structure. For example, the display 14 may be attached to walls, moving vehicles, buildings, bridges, and the like to enable the display of video images as needed. In particular, the display 14 comprises a matrix of flexible display modules 30 that are interconnected so as to minimize the amount of cabling needed to route power from a power source 40 and data from a video processing system 50 maintained aboard the airship 20. The video processing system 50 is configured to convert source data received from various video input sources, such as a video camera or a prerecorded video source, such as a DVD (digital video disc) player or video cassette player, into a serial data signal that is formatted so as to be compatible for rendering upon the display 14. In particular, the video display system 10 is configured to provide various data signals, such as PWM (pulse width modulation) signals to control the intensity of the various LED pixels maintained by each display module 30 based on the amount of available power supplied to the display 14 by the power source 40. The video display system 10 is also configured to stagger PWM (pulse width modulation) drive signals supplied to the LED pixels, so as to equalize the electrical load seen by the power source 40 maintained by the airship 20. Furthermore, the display modules 30 are configured so as to be attached to the outer surface of the airship 20 in a flexible manner, so as to accommodate the expansion and contraction of the envelope 18 that is experienced when the airship changes altitude. As such, the display system 10 provides a lightweight and low-power system in which video images are displayed in a large-scale format in high-resolution.

Although the display 14 is discussed primarily as being configured to be attached to the airship 20, it should be appreciated that the display 14 may be attached to any other suitable support structure, including a structure that is transportable from one place to another. In one aspect, the support structure may be placed upon a heavy-duty fabric or the like that is foldable to allow for easy transportation of the display system 10 when not in use. For example, the support structure may be attached to moveable support scaffolding and the like for use at any desired event, including concerts and sporting events.

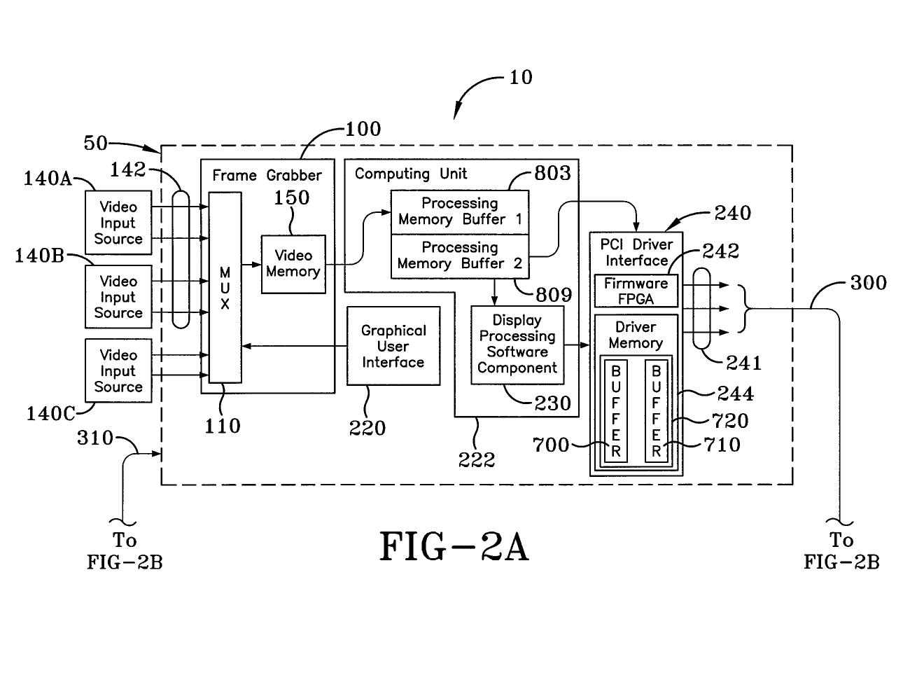

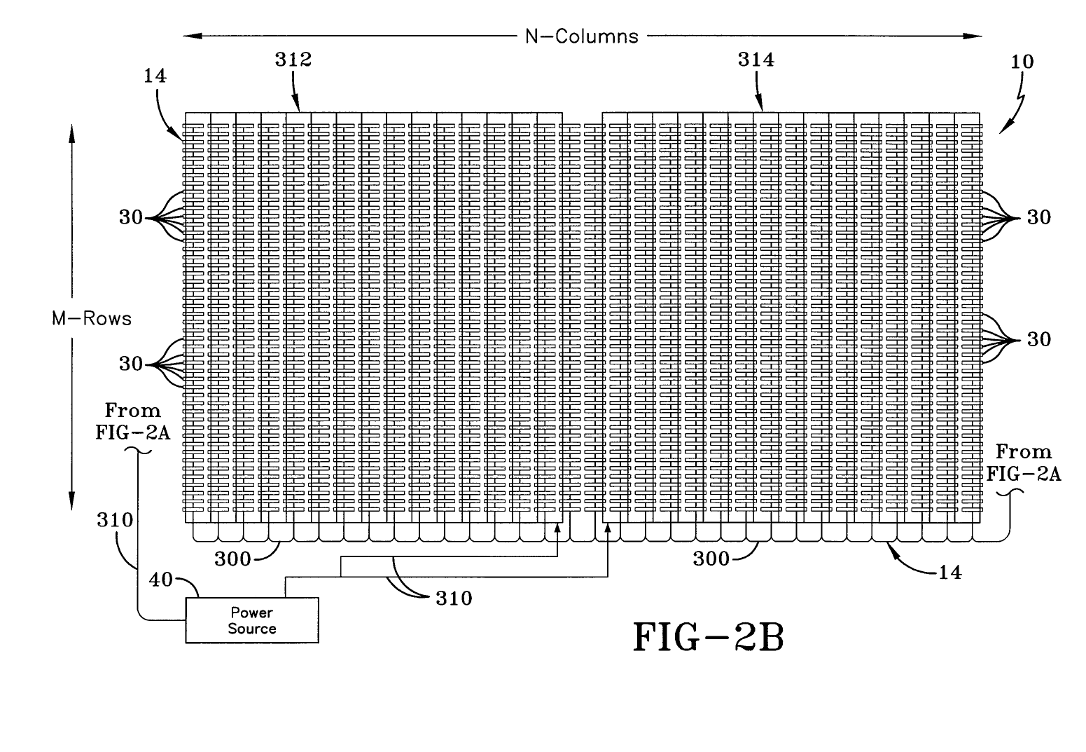

Continuing to FIGS. 2A-B, the video processing system 50 maintained by the display system 10 that is used to render images for presentation upon the display 14 may comprise a general-purpose or application specific computer system that is configured with the necessary hardware and/or software to convert various multimedia source data into a compatible format, along with suitable control signals to enable the rendering of an image upon the display 14.

In particular, the video processing system 50 includes a frame grabber 100 that may be implemented in hardware, software, or a combination of both. In one aspect, the frame grabber 100 may comprise an ACCUSTREAM 170+ frame grabber that is manufactured by Foresight Imaging, LLC, which supports display resolutions up to 1600×1200 at 60 Hz for example, although any other suitable frame grabber could be used. The frame grabber 100 maintains a multiplexer 110 that is configured to select among one or more multimedia input sources coupled thereto, such as video input sources 140A-C, which comprises any device capable of supplying a suitable video input data signal 142 that is compatible with the operation of the video processing system 50. For example, the video input sources 140A-C may comprise a video camera maintained aboard the airship 20, used to capture a live event, and as such provides a live feed for presentation upon the display 14. Or the input source may comprise any component, such as a video cassette player, a DVD (digital video disc) player, an Internet site, a BLU-RAY player, a flash memory card, a wireless transmission, or other component or device, such as a computer configured to generate a video input data signal 142 from a multimedia source. As such, the frame grabber 100 converts the video input data signal 142 supplied from the input sources 140A-C into digitized high-resolution data that is temporarily stored at a video memory 150 maintained by the frame grabber 100. It should also be appreciated that the video memory 150 may comprise any memory, such as volatile memory, nonvolatile memory, or a combination of both that is compatible with the operation of the display system 10.

In order to select the particular video input source 140A-C that will supply the desired video input data signal 142 for rendering the video image upon the display 14, a user interface, such as a graphical user interface (GUI) 220 is presented upon a monitor or other suitable display device. The GUI 220 operatively communicates with the multiplexer 110 and enables a user of the system 10 to visually select which input source 140A-C is to be made operational in a user-friendly and convenient manner. Moreover, the GUI 220 may also provide various controls that allow the user to manipulate or adjust various parameters associated with the input sources 140A-C and the display 14. For example, the GUI 220 may allow adjustment of the brightness, color temperature, refresh rates, and the like associated with the display system 10. After the desired input source 140A-C has been selected, the high-resolution input data stored at the video memory 150 via the frame grabber 100 is processed by a computing unit 222 that executes a processing software component 230 via memory buffers that will be described later. The processing software component 230 is configured to filter and/or decimate the high-resolution data from the frame grabber memory 150 into a data signal that is formatted at a resolution that is compatible with the resolution of the display 14. That is, the processing software 230 is configured to convert the high-resolution video source data into a lower resolution processed or decimated data signal that matches the number of vertical (column) and horizontal (row) pixels maintained by the display 14. For example, the processing software component 230 may be configured to convert the resolution of the input data signal 142 into a resolution of 256 (columns)×144 (rows) or any other resolution that matches that of the display 14.

Once formatted, the lower resolution decimated data signal is supplied to an interface device, such as a PCI driver interface 240, which maintains the proper hardware and/or software to generate a serial interface signal 241 that is compatible with the components maintained by the display 14. In one aspect, the PCI driver interface 240 may be embodied in hardware, software, or a combination of both. For example, the PCI driver interface 240 may include an FPGA 242 (field-programmable gate array) that maintains suitable firmware, and a driver memory 244, such as random access memory (RAM), that is configured to process the signals received from the processing software component 230 into a format that is compatible with the operation of the display 14. In one aspect, the processing software component 230 may be configured to process the data signal received from the frame grabber 100 and transfer it to the PCI driver interface 240 in real-time in order to display live images upon the display 14. In particular, the PCI driver interface 240 formats the decimated video data signal generated by the processing software component 230 into the serial interface signal 241 that is communicated to the display 14 via a data control line 300. The serial interface signal 241 provides compatible video data and control data that enables the display 14 to render video images thereon in a manner to be discussed below.

To energize the system 10, the power source 40 supplies power to a power bus 310 that is coupled to the display 14 and the video processing system 50. In one aspect, the power source 40 may comprise a DC (direct current) power supply, which includes a 28V unregulated power source to illuminate display panels maintained by the display modules 30 and an unregulated 8V source to drive the control circuitry maintained by a control panel maintained by the display modules 30 to be discussed. Of course, these voltage values may change in accordance with the number of display modules 30 maintained by the display 14. Moreover, one skilled in the art will appreciate that the total amount of electrical current required to operate the system 10 is dependent upon the number of display modules 30 provided by the display 14. It should be appreciated that the power source 40 may also include an AC (alternating current) power supply that converts into DC power that is compatible with the operation of the system 10.

The display 14, shown in FIG. 2B comprises a plurality of display modules 30 that are arranged in a matrix or array of M-rows by N-columns. The modules 30 are connected along each column (N) to the power source 40 via the power bus 310 and to the video processing system 50 via the data control line 300. It should be appreciated that the power bus 310 may be split into 2 or more grids that independently power discrete sections of the display 14. For example, as shown in FIG. 2B, the power bus 310 is configured as two separate grids 312 and 314.

It should be appreciated that the multiple separate grids 312 and 314 provide multiple parallel paths, due to their horizontal and vertical interconnection, to supply power to each display module 30. This produces a synthetic power plane that minimizes voltage drops, as well as minimizes noise associated with grounding and powering the display 14. The multiple separate grids 312 and 314 also balances or equalizes the distribution of power across the display when variations in display intensity are encountered based on the content of the video image being rendered. Yet another benefit associated with the use of multiple separate power grids 312 and 314 is that the gauge of the wiring used to embody the power bus 310 is reduced, resulting in a significant reduction in weight of the overall display 14. Such weight reduction is highly beneficial when the display 14 is utilized with the airship 20, as it allows less power to be consumed by its propulsion systems, during its launch and when it is being navigated during flight.

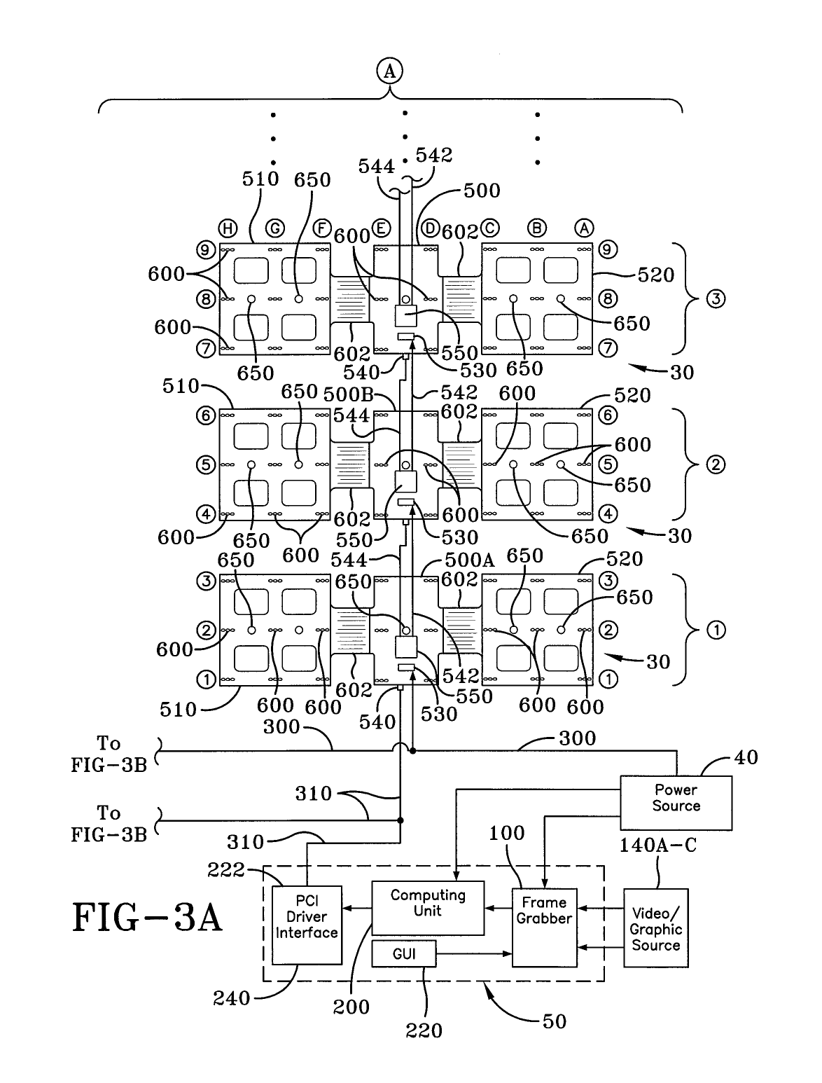

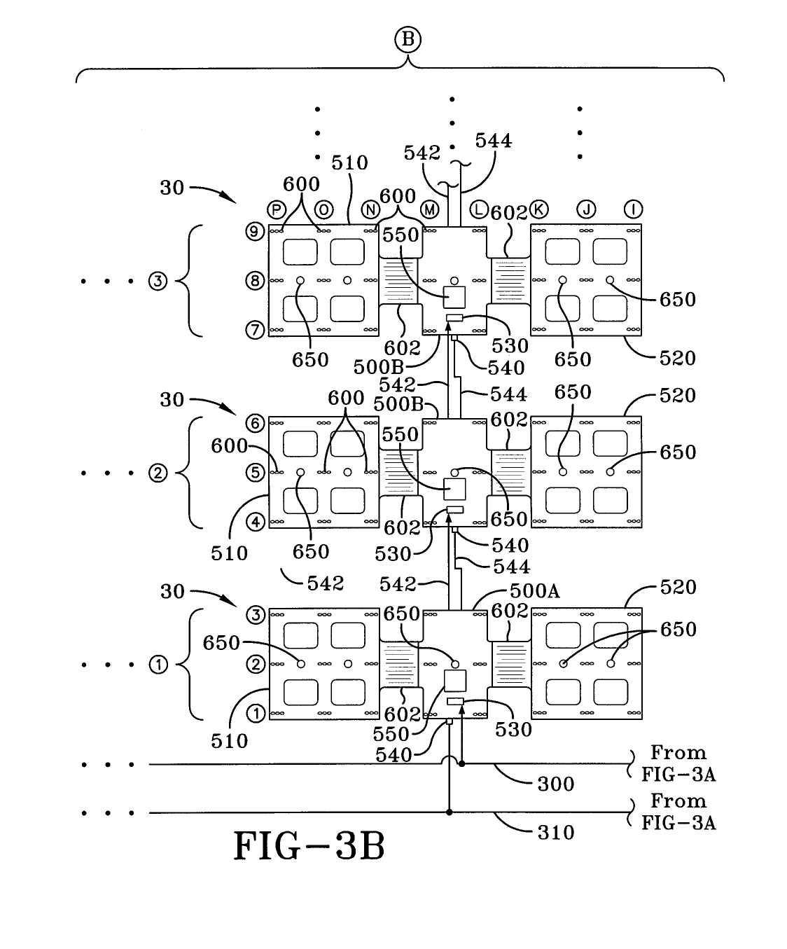

Continuing, for the purpose of clarity, the location of the display modules 30 within the display 14 will be identified by the intersection of the rows (M) and columns (N), whereby the rows are identified by the numeric characters 1, 2, 3, etc. . . . and the columns are identified by alphanumeric characters A, B, C, and so on, as shown in FIGS. 3A-3B. As such, row 1, column A identifies the display module 30 that is located in the lower left-hand corner of the display 14. As such, the video processing system 50 generates serial interface signals 241 that are supplied to each of the display modules 30 that are powered by the power source 40 to enable their individual operation thereof so as to render a completed video image upon the display 14.

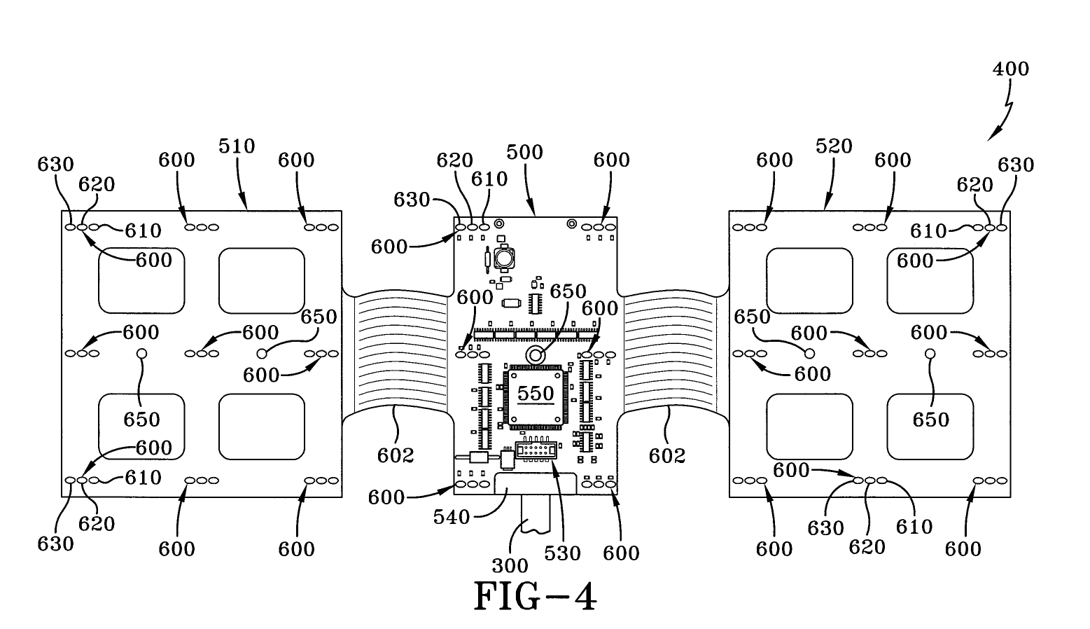

Continuing to FIGS. 3A, 3B and 4, each display module 30 maintained by the display 14 comprises a control panel 500 that is coupled to a pair of display panels 510 and 520. FIG. 3A represents the display modules 30 that form the right lowermost portion of the display 14 and FIG. 3B represents the display modules 30 immediately to the right of the modules shown in FIG. 3A. The control panel 500 includes a power connector 530 and a data connector 540 that are configured to enable power and data to be transferred through each column (N) of display modules 30 via respective power communication lines 542 and data communication lines 544. It should be appreciated that the power connector 530 and the data connector 540 associated with the display modules 30 of row 1 of the display 14 are directly coupled to the power bus 310 and the data control line 300 respectively. And the power communication lines 542 and the data communication lines 544 serve to couple the power bus 310 and the data control line 300 to each vertically adjacent row of display modules 30 of the display 14.

A control unit 550 maintained by each control panel 500 processes the serial interface signal 241 and power respectively received from the data control line 300 and the power bus 310. The control unit 550 comprises a field programmable gate array (FPGA), which is configured to generate pulse width modulation (PWM) signals based on the data content of the serial interface signal 241 to control the illumination intensity of a plurality of pixels 600 maintained by the control panel 500 and each of the display panels 510 and 520 that are coupled to the control panel 500 via a flexible communication link 602, such as a ribbon cable. The flexible communication link 602 may comprise wire, fiber optics or other medium that enables the control panel 500 to communicate various data with the display panels 510,520, while allowing the panels 500,510,520 to move independently as the envelope 18 alters its shape as it changes altitude. That is, the use of the flexible ribbon cable 602 to electrically couple the pixels 600 of the display panels 510,520 with the control panel 500 is particularly advantageous to the utilization of the display system 10 when mounted to the external surface of the envelope 18 of the airship 20, as it is able to adapt to changes in the profile of the envelope's surface to which the display 14 is attached, without resulting in damage to the structure of the display modules 30.

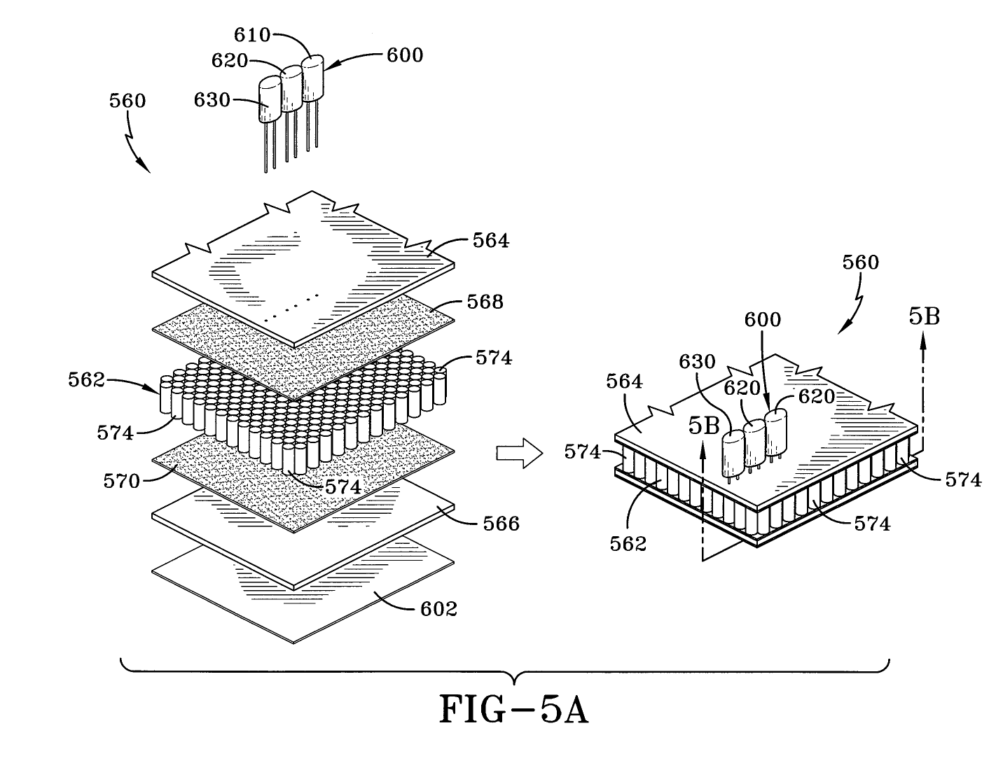

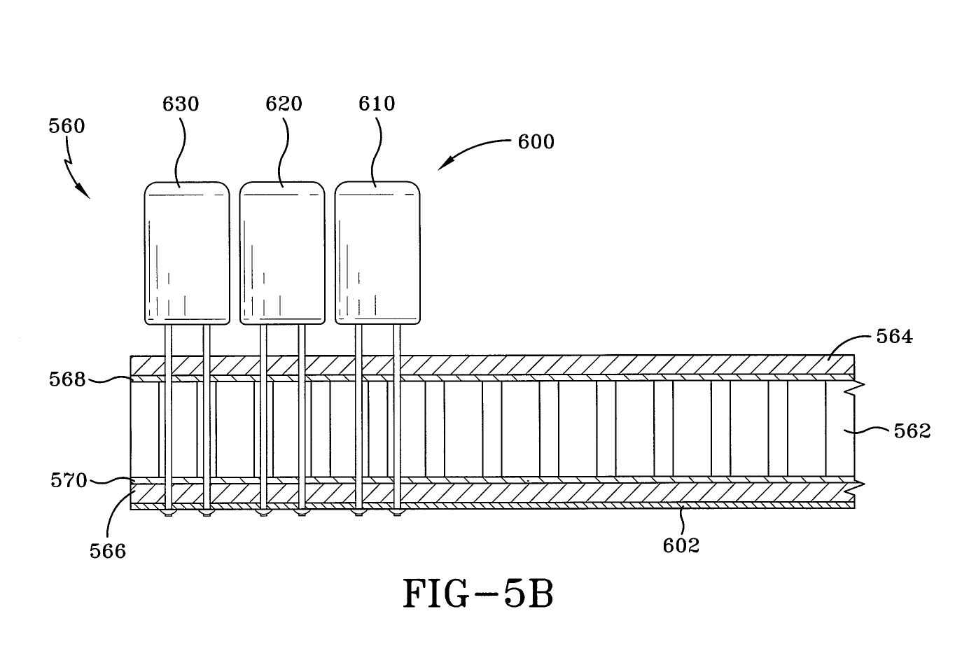

The control panel 500 and the display panels 510,520 may be formed from a fiberglass circuit board or any other suitable material. In another aspect, the display panels 510,520 may be formed of sandwich sheet or board material 560, such as fiberglass facing sheets with aramid fiber or thermoplastic polyurethane core material, such as GILFAB 5075 panels, manufactured by MC Gill Corp. As shown in FIGS. 5A-B, the material 560 provides a lightweight structure for attachment of pixels 600 which, as will be described in further detail, are made up of LEDs 610-630. In particular, the sandwich sheet material 560 may comprise a honeycomb core or layer 562 that is laminated between an upper face sheet 564 and a lower face sheet 566 via respective adhesive layers 568 and 570. Specifically, the honeycomb layer 562 comprises a matrix of interconnected open cells 574 that maintains air therein. The cells 574 may have any cross-sectional shape, such as cylindrical, hexagonal or the like. As such, the use of the sandwich sheet material 560 reduces the weight of the display modules 30, which is highly desirable for use with an airship 20.

The pixels 600 maintained by the control panel 500, as shown clearly in FIGS. 3A, 3B and 4 are arranged in a matrix of 3 rows and 2 columns, while the pixels maintained by the display panels 510,520 are arranged in a matrix of 3 rows and 8 columns, such that each complete display module 30 comprises a resolution of 8×3 pixels. To form the display 14, the display modules 30 may be coupled together in a manner, such that in one aspect, the display 14 is comprised of a matrix of display modules 30 that are arranged in a configuration of 32 columns by 48 rows, to provide a total resolution of 256×144 pixels in a 16:9 aspect ratio. However, it should be appreciated that the display 14 may be configured with any number of rows and columns to achieve the resolution needed. Each pixel 600 comprises a red, green, and blue LED (light emitting diodes) 610,620,630, which when additively combined, enable the rendering of full-color images upon the display 14. It should be appreciated that the red, green, and blue LEDs 610, 620, and 630 may be arranged in any suitable arrangement to form the pixel 600, so long as the LEDs 610,620,630 are suitably adjacent to one another to enable the generation of a full range of perceptible colors. That is, when the interface signal 241 is received by the control panel 500 associated with each display module 30, it generates a PWM pulse width modulated) signal that controls the intensity that is output by each of the red, green, and blue LEDs 610,620,630 that comprise each pixel 600. By controlling the intensity levels of the red, green, and blue LEDs 610,620,630, any color image can be rendered upon the display 14. It should also be appreciated that the configuration of the display modules 30 enables the display of color images during ambient lighting conditions experienced during both night and day. In one aspect, to enhance daytime viewing of the display 14, the power delivered to the display modules 30 may be controlled to adjust the intensity of the pixels 600. Additionally, other adjustments to the characteristics of the image, such as contrast adjustment, can be implemented by the video processing system 50 to increase the intensity or enhance the viewing of the video image displayed by the display 14 during the day.

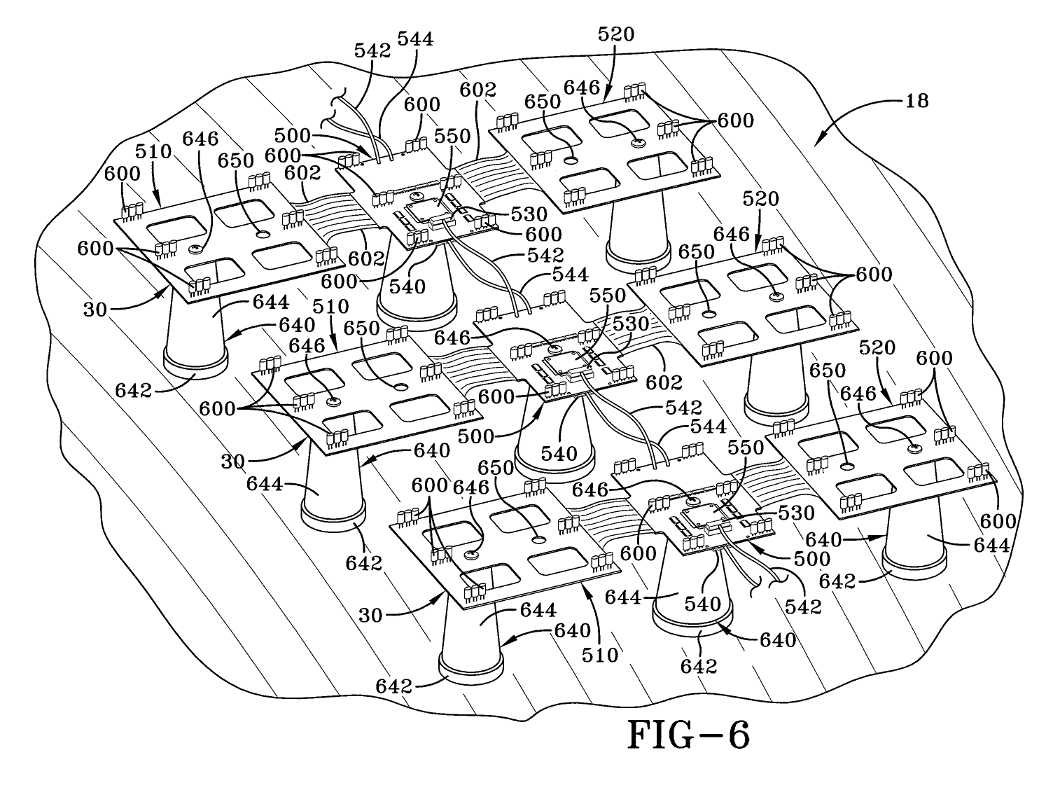

In addition, the control panel 500, and the display panels 510 and 520 include one or more mounting apertures 650 to enable the panels 500,510,520 to be attached to various standoffs 640 that extend away from the outer surface of the envelope 18 of the airship 20 using any suitable fastener, as shown in FIG. 6. Specifically, the standoffs 640 are comprised of a button 642 that is attached to the surface of the envelope 18, using any suitable means of fixation, such as adhesive for example. Extending at a substantially right angle from the button 642 is an offset member 644 that is attached to the panels 500,510,520 using a suitable fastener 646 that is received through the mounting apertures 650 and threadably retained within the offset member 644. In some embodiments, not all of the apertures 65 are associated with a standoff 640 and a fastener 646. Additionally, it should be appreciated that the offset member 644 may be snap fit within the button 642, or retained thereto using any suitable means of fixation, such as adhesive for example. It should be appreciated that the use of the mounting apertures 650 along with the use of the removable fasteners 646 greatly facilitates the ease in which damaged or defective display modules 30 may be replaced, thus enhancing the ease in which the display 14 is maintained. It also allows the dimensions of the display 14 to be readily altered without expending significant time or resources, as the display modules 30 may be added to or removed from the display 14 to form any dimension or resolution desired. Furthermore, because the mounting system employed adds minimal weight to the airship 20, a reduction in energy is realized in the energy needed to move the airship 20 from a docked position on the ground to a launched position, and vice versa. Moreover, the cabling associated with the power communication line 542 and the data communication lines 544 that extend between the various display modules 30 of the display 14 may be held together via TY-RAPs™, or any other suitable retention strap or harness, to limit that the such lines 542,544 do not catch or snag any surrounding protrusions during the handling, as well as during the ascent and descent of the airship 20.

While the control panels 500 of each of the display modules 30 have the primary function of controlling the illumination intensity of each of the LEDs 610-630 associated therewith, the control panels 500 also provide specialized functionality to facilitate the operation of the display 14. That is, the control panels 500 are identified by the suffix designations A and B to indicate the particular operating features that they maintain, and their physical location within the matrix of row (M) and column (N) of the display 14. In particular, control panels 500A, which are also referred to as a column driver panel, maintain control units 550A that are located on the bottom row of the display 14, and as such function to receive a portion of the serial interface signal 241 output by the system 50 via the data control line 300, which represents a portion of the image to be displayed. Control panels 500B, which are referred to as column matrix panels, maintain control units 550B that are located in the same column and immediately above row 1 that maintains column driver panel 500A. It should be appreciated that the control panel 500 of each display module 30 is configured, such that control units 550 provide both column driver and column matrix operating functions, which can be invoked when such functions are needed. This feature enhances the modularity of the display 14, and simplifies the replacement of a failed display module 30 regardless of its location in the display 14. Thus, once the bottom row 1 of column driver panels 500A are loaded with image data from the interface signal 241, the data is subsequently transferred upward through each column to each of the column matrix panels 500B. And as more serialized data is loaded into the column drivers 500A, the data is repeatedly shifted upward within each column to fill each of the display modules 30 maintained by the display 14.

One advantage of the present invention is that the display panels 510,520 carry no driving electronics and therefore, if any LED 610-630 is rendered defective due to environmental or other matters, it can be readily replaced. Moreover, by restricting the electronics to the control panel 500, the weight of the display 14 is significantly reduced to allow the display 14 to have additional pixel density. As previously discussed, each control panel 500 includes the power connector 530 and the data connector 540 for distributing power and data between the display modules 30 in each column (N). As best seen in FIG. 2, the power bus 310 is configured so as to enter the display module 30 from the top and the bottom. This allows redundancy among the display modules for the distribution of power to as many display modules 30 as possible even if power to one of the panels is cut.

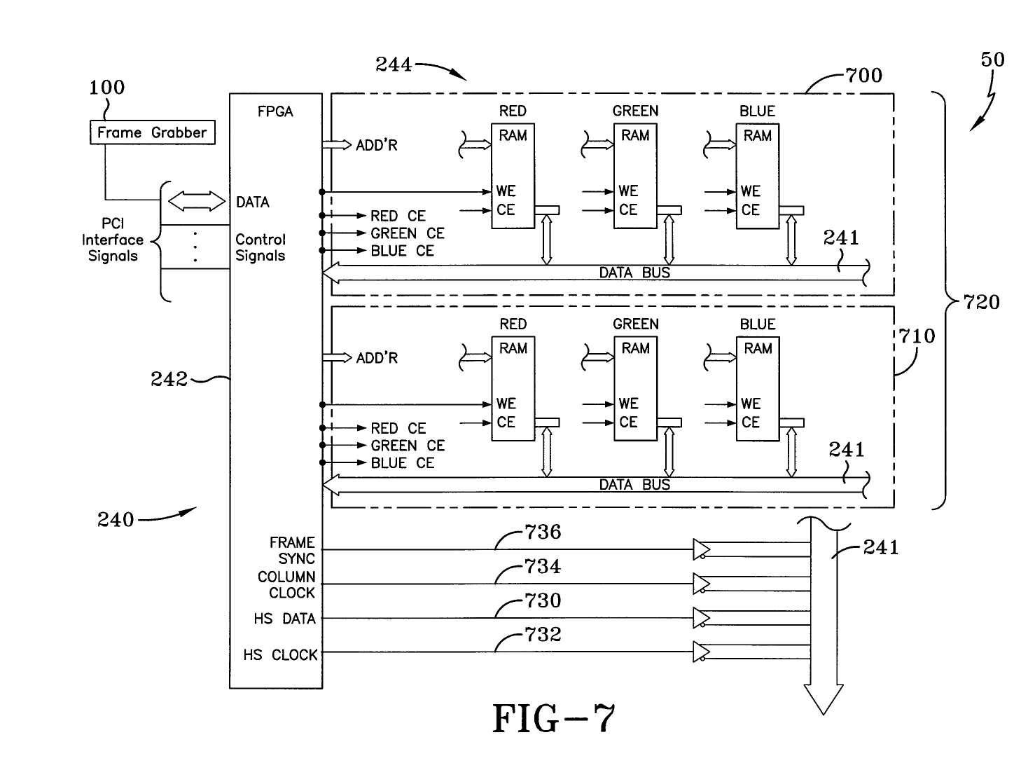

Referring now to FIGS. 2A and 7, to enable the transfer of serial data with the necessary speed, the driver memory 244 maintained by the PCI driver interface 240 includes a first and a second static RAM buffer 700 and 710 that together form a ping-pong memory unit 720. The ping-pong memory unit 720 allows the video processing system 50 to load the decimated data signal generated by the processing software component 230 into the first RAM buffer 700 at the same time as the PCI driver interface 240 is generating the interface signal 241 that contains the serial data stored in the second RAM buffer 710 to the display 14 via the data control line 300. In particular, the serial data control signal 241 includes, but is not limited to, a high speed data signal 730, a high speed clock signal 732, a column clock signal 734, and a frame synchronization signal 736, as shown in FIG. 7.

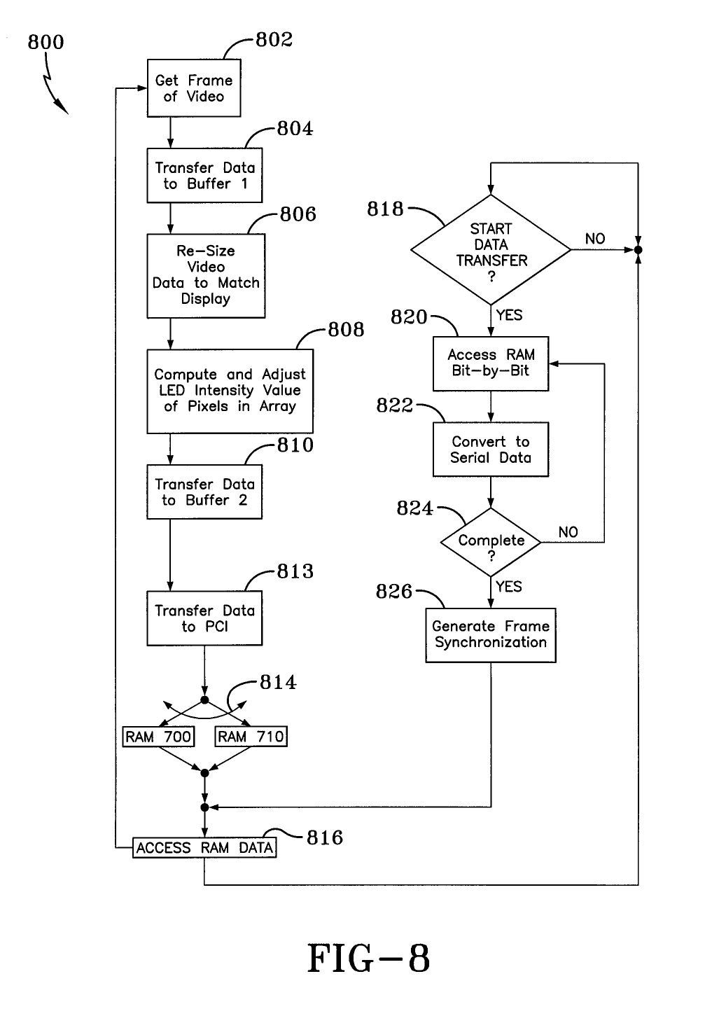

With the components of the display system 10 set forth, the following discussion is directed to the operational steps for carrying out the processing of the input data signal 142 supplied from the input sources 140A-C, which are generally indicated by the numeral 800, as shown in FIG. 8. Initially, at step 802, the frame grabber 100 obtains a frame of video from one of the input sources 140A-C. The video processing system 50 initially monitors the frame grabber 100 to determine when a frame of video is available in the frame video memory 150 of the frame grabber 100. When a frame of video is stored at the video memory 150, the processing software component 230 initiates a direct memory access (DMA) operation in order to transfer the data in the frame grabber memory 150 into a first processing memory buffer 803 in the internal memory of the computing unit 222 maintained by the video processing system 50 as indicated at step 804. Subsequently, at step 806, the processing software component 230 functions to decimate the data contained in the first processing memory buffer 803 by discarding unneeded pixel data that forms the currently processed frame of the video in order to make the aspect ratio of the video image in the first processing memory buffer 803 match the M×N (row×column) configuration of the display 14.

Because the power source 40 is only able to supply a finite amount of electrical current to power the pixels 600 of the display 14, as well as to power the other components aboard the airship 20, the software component 230, at step 808, computes and adjusts a running sum of all the intensity values for all the pixels 600 in the display 14 based on the particular frame of video to be displayed. The processing software component 230 compares this intensity value to a limit that is based upon the electrical current available to illuminate the display 14 and the total number of pixels in the display 14, and normalizes or adjusts a pulse width modulation (PWM) count, if necessary, for each pixel 600 so as to effectively reduce the brightness or intensity of the display 14, so that the frame of video corresponds to the amount of electrical current available from the power source 40. It should be appreciated that the conservation of power from the power source 40 is critical to the compatible operation of the display 14 with various electronic systems that are aboard the airship 20, which are also powered by the power source 40.

When the conversion and normalization process is complete, the data is written into a second processing memory buffer 809 at step 810 in preparation for transferring the data to the PCI display driver interface 240, which the processing software component 230 treats as a block of memory. As shown in FIG. 7, digitized data, which is obtained from the frame grabber 100, contains eight-bit intensity values for the red, green, and blue LEDs 610,620,630 for each pixel 600. The processing software component 230 thereby creates a 24-bit data word, which is written into the second processing memory buffer 809, so that the format of the data matches the configuration of the ping-pong RAM buffers 700 and 710 of the ping-pong memory unit 720 maintained by the PCI driver interface 240. As will be appreciated by those skilled in the art, the hardware of the PCI driver interface 240 is designed so that its 12 least-significant address lines are reserved for defining the horizontal address of each pixel, while the 12 most-significant address lines define the vertical address of each pixel 600 in the display 14. For example, an address of all zeroes corresponds to the top left-most pixel. As such, if the configuration of the display 14 is less than 256 pixels wide for any row, data written into memory locations with the upper addresses of the eight-bit horizontal address larger than the size defined by the PCI horizontal size register will be ignored. The pixel intensity information of the 24-bit word used to control the illumination of each pixel 600, is therefore stored in a rectangular fashion as a horizontal and vertical address in a format much like A1, A2, . . . Zx. This storage configuration corresponds to the row and columns of the display 14, as shown in FIG. 3A-B, which matches the hardware counter circuitry within the FPGA 242 maintained by the PCI driver interface 240.

Once the data has been transferred into the second processing memory buffer 809 so that it matches the configuration of the ping pong memory unit 720 of the PCI driver interface 240, the process continues to step 813, where the video processing system transfers the data to the PCI driver interface 240 using one of its DMA channels. At step 814, the video processing system 50 selects which ping-pong RAM buffer, 700 or 710, is to be loaded. The video processing system 50 makes this determination based upon which RAM buffer 700,710 is currently sending a frame of video to the display 14. The processing software component 230 monitors a status signal from the PCI driver interface 240 to determine if the hardware transfer of the previous video frame from the other RAM buffer 700,710 of the ping-pong memory unit 720 is complete. If it is, the software component 230 writes to a control register on the PCI driver interface 240, which switches RAM on the ping-pong memory 720, allowing the PCI interface driver 240 at step 816, to access the RAM buffer 700,710, which was just loaded. The processing software component 230 then sends another control signal at step 818, which triggers the PCI driver interface 240 to send the serial interface signal 241 to the display 14 via the data control line 300.

In order to generate a video image at about 30 frames per second, the video processing system 50 immediately starts processing another frame of data from the frame grabber board 100 by returning to step 802 from step 816 while the PCI driver interface continues to transfer data to the display 14, as indicated at steps 818-826. As such, steps 802-816 are continually repeated by the video processing system 50 in order to produce each frame of the video image.

As set forth in steps 818-826, the PCI driver interface 240 effectively converts the 24-bit pixel intensities stored in RAM buffer 700 and 710 that correspond to a frame of video into a serial bit stream, which matches the arrangement of the display modules 30 that form the display 14. The individual data bits used to control the intensity of the red, green, and blue LEDs 610,620,630 are accessed in a scattered sequence due to the way that the control panels 500 of each display modules 30 are connected, and because each control panel 500 controls a 3×8 matrix of pixels 600. This conversion effectively transforms the rectangular digital image information from the image source 140A-C into a serial bit stream that is compatible with the display 14. In other words, a line-by-line process would normally submit the data signal to a video display in a sequence of: row 1, columns A-Z; row 2, columns A-Z; row 3, columns A-Z, and so on. The use of such a data transmission scheme is incompatible with the display 14 due to the manner in which the serial shift registers of the control unit 550 are configured to cascade the LED intensity data through to each of the display modules 30. Accordingly, the video processing system 50 generates the serial output data stream and associated control signals 730,732,734,736 in the form of the serial interface signal 241 in a sequence to drive any configuration of the display 14.

In order to accomplish the foregoing, the PCI driver interface 240 utilizes the RAM buffers 700,710, and the FPGA 242, as shown in FIG. 7, which includes two control registers that are loaded to control the number of horizontal and vertical pixels in the display 14, and a control register to control the hardware operation of the PCI board. The FPGA 242 generates the control signals 730-736 to interface with the first column control unit 550A that receives the data interface signal 241. Accordingly, at step 818, the PCI driver interface 24 initiates the serial data transfer. As noted previously, the PCI driver interface 240 includes the RAM buffers 700,710, of the ping-pong memory unit 720, so that as the video processing system 50 is loading one RAM buffer 700, the other RAM buffer 710 is accessed by the FPGA 242 which selects the individual bits of memory, as indicated at step 820, in the correct sequence to format the serial data for delivery to the display 14. Counter and data selector circuitry are implemented in the FPGA 242 to access the RAM buffers 700,710 to generate the serial bit stream, as indicated at step 822, in order to match the manner in which the serial shift registers included in the control unit 550 are cascaded in the display 14.

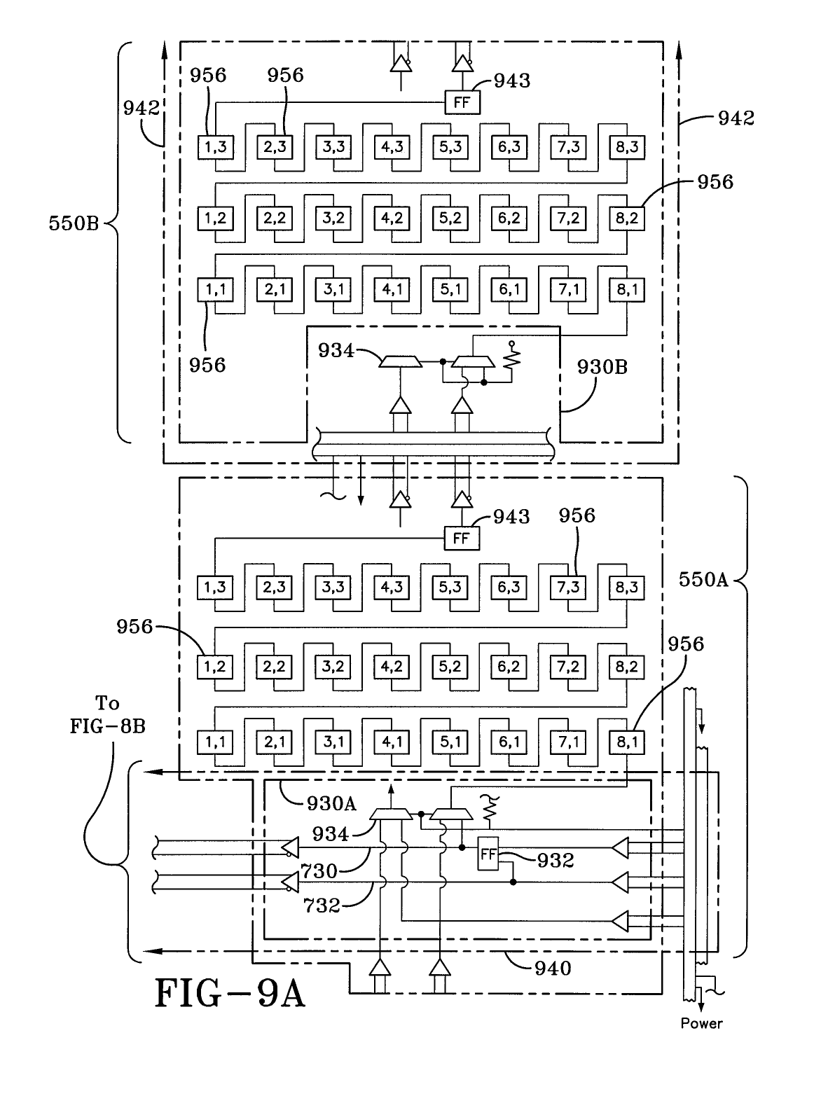

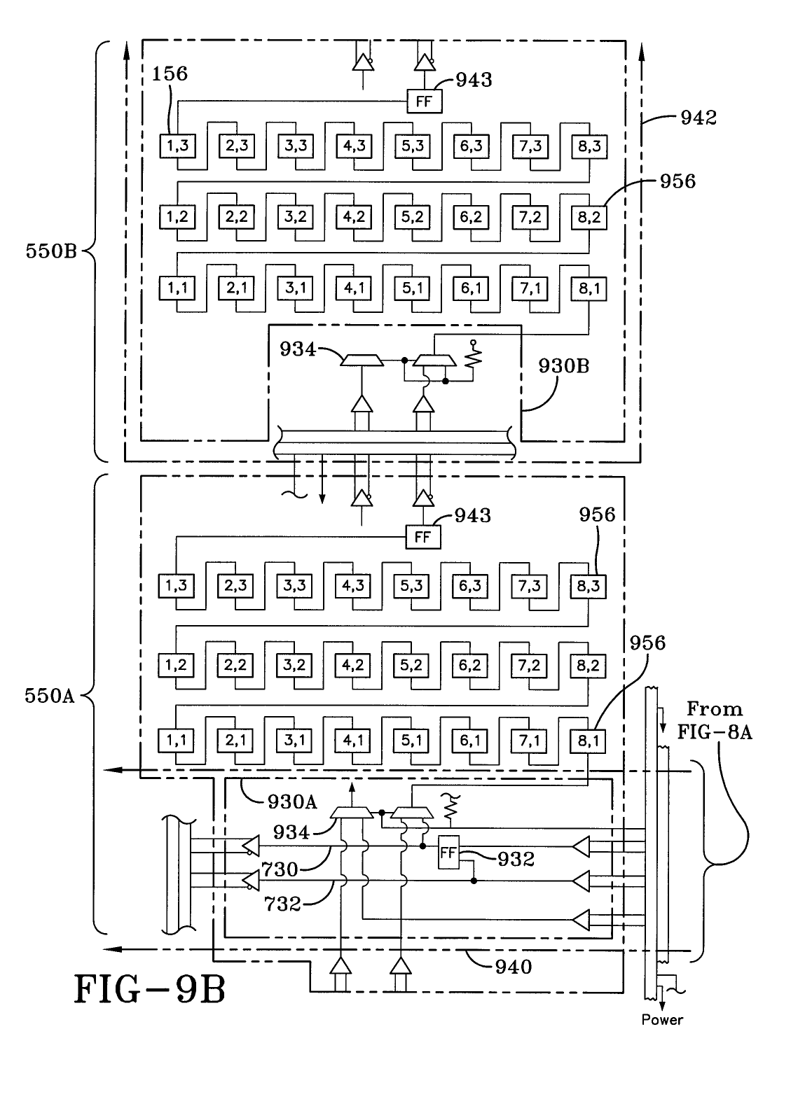

The generation of the serial interface signal 241 for steps 820 and 822 will be described for an exemplary implementation of the display modules 30, however other sequences could be generated for other configurations of display modules 30. Referring now to FIGS. 9A-B, a portion of the control units 550A,550B of each associated control panel 500A,500B are shown. Specifically, it should be appreciated that the control panels 500A are also referred to as column driver mode panels, due to their position in the bottom row of each column of the display 14, while all other control panels 500B maintained by the display 14 are referred to as display mode panels. In particular, FIG. 9A shows the lowermost portions of two columns adjacent one another. Contained within each control unit 550A,550B is a data cascade circuit 930A,930B, respectively. The data cascade 930A includes a flip-flop 932 to shift the incoming serial data contained within the interface signal 241 horizontally. The data cascades 930A and 930B both contain multiplexers 934 that assist in transferring the serial data signal through each of the display modules 30. For the data cascade 930A, the multiplexer 934 functions to transfer data from the flip-flop 932 horizontally, while the multiplexers 934 in the data cascade 930B function to transfer the serial data of the interface signal 241 vertically. Collectively, all the data cascade circuits 930A in a row form a horizontal shift register 940. And all the data cascade circuits 930B in a column collectively form a vertical shift register 942. As such, the serial data of the interface signal 241 is transferred vertically between control units 550 via flip-flops 943, whereas the output of each of the flip-flops 932 are connected to the input of each adjacent flip-flop 932 of the data cascades 930A maintained by the control units 550A. Moreover, the output of each flip-flop 932 also provides an input signal to a plurality of 24 pixel drive controls 956 maintained by the control units 550 that are used to transfer intensity data for each display module 30 vertically within each column of the display 14. Each pixel drive control 956 and associated pixels 600 are both identified by two-digit numerical designators, whereby the first numeral (1-8) designates the column, while the second numeral (1-3) designates the row.

Thus, each display module 30 is likewise connected to the next display module 30 all the way up each column, such that the last bit in the chain of pixel drive controls 956 cascades to the input of the shift register maintained by the next display module 30 in each column. Such a configuration provides one horizontal high-speed data path along the bottom row of display modules 30, and through each column of the display 14, via flip-flops 932. Then once every column has one bit of data, a slower column clock signal propagates the data in parallel up each column of display modules 30. The resulting configuration enables the data rate of all the circuitry, except the flip-flops 932, to be much slower. In addition, the clock rate of the circuitry of the control unit 550 is greatly reduced, resulting in much lower power consumption by the display 14. Thus, such operation provides reduced power consumption and reduced EMI (electromagnetic interference) radiated emissions from the display 14 as well.

FPGA 242 of the PCI driver interface 240 is designed to access the individual bits of intensity data, which are stored in the rectangular ping-pong memory unit 720 in the correct sequence to match the configuration in which the display modules 30 are cascaded. The approach used to load the display 14 is to access the rectangular ping pong memory unit 720 so that one bit of the data signal 730, is loaded into each column driver mode panel 500A via the high speed clock signal 732, across the bottom row of the display 14. Once every column driver panel 500A contains one bit of data, the control circuitry generates the relatively slower column clock signal 734 to simultaneously shift the data into the vertical shift register 942 and into the set of pixel drive controls 956. The sequence of sending one bit of data for each column driver 550A horizontally at a high-speed rate, followed by a slower column clock signal 734 to shift the data simultaneously through all the display modules 30 cascades the data horizontally and vertically through the display 14. When all of the required clock signals have been generated to load all the intensity data into all the display modules 30, each of the pixel drive controls 956 contain 24 bits of intensity data (8 bits for red LEDs 610, 8 bits for green LEDs 620, and 8 bits for blue LEDs 630), which is used to control the pulse-width-modulated (PWM) drive signals for the red LEDs 610 (bits 23 through 16), the green LEDs 620 (bits 15 through 8), and the blue LEDs 630 (bits 7 through 0). As such, each of the pixel drive controls 956 contains a shift register, such that the most significant bit (MSB) of the shift register maintained by the pixel drive control (8,1) is cascaded through to the other pixel drive controls (7,1), (6,1), (5,1), (4,1), (3,1), (2,1), and (1,1) in the lower row of the display module 30, then cascaded to pixel drive controls (8,2), (7,2), (6,2), (5,2), (4,2), (3,2), (2,2), (1,2) of the middle row of the display module 30, and then cascaded to pixel drive controls (8,3), (7,3), (6,3), (5,3), (4,3), (3,3), (2,3), and (1,3) of the top row of the display module 30. It should be appreciated that the most significant bit (MSB) of the shift register of the pixel drive control 956 becomes the data output from the current display module 30.

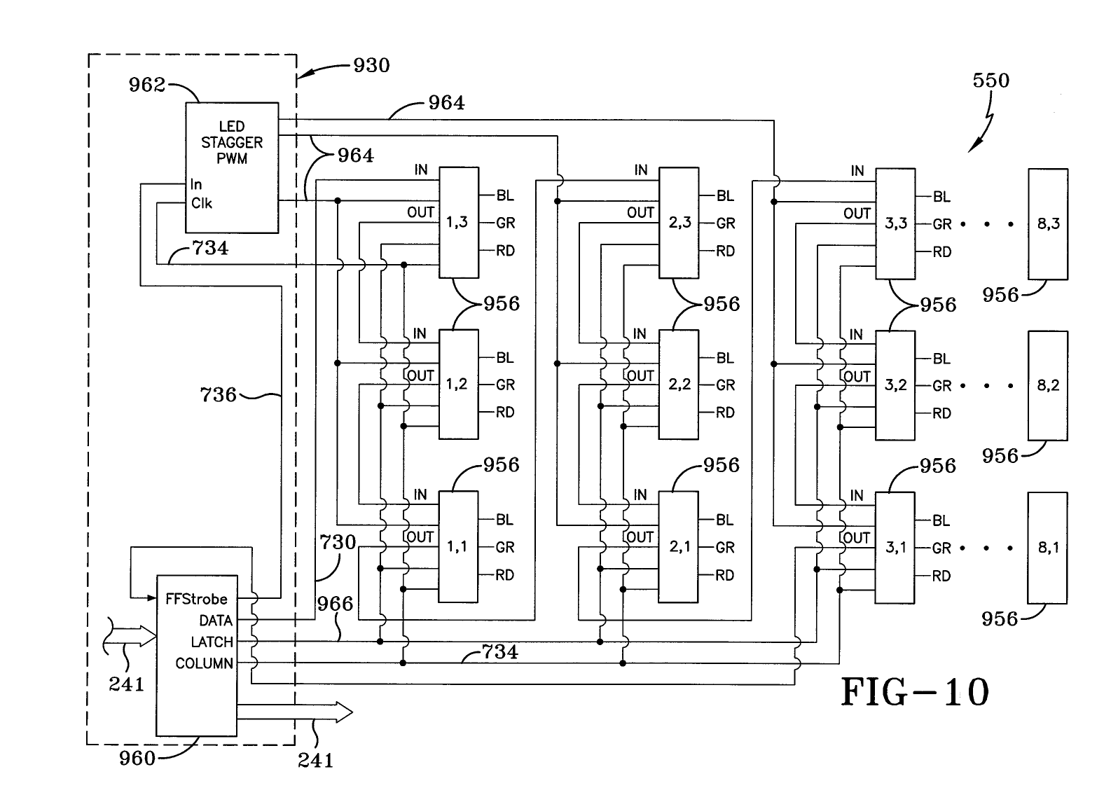

Continuing to FIG. 10, the manner in which the data maintained by the serial interface signal 241 and control signals 730,732,734, and 736 is utilized by the control unit 550 will now be presented, whereby in addition to the flip-flops 932,943 and the multiplexers 934, the data cascade 930 of the control unit 550 includes a data circuit 960, and an LED stagger pulse width modulator 962. As such, the serial interface signal 241 is received by the data circuit 960, which distributes portions of the image information as needed to the pixel drive controls 956. The data circuit 960 distributes the frame synchronization signal 736 and the clock signal 734 to the LED stagger pulse width modulator 962, which in turn generates a set of three stagger signals 964 which are distributed to the lower (8,1-1,1), middle (8,2-1,2) and upper (8,3-1,3) pixel drive controls 956. This is done for the purpose of equally distributing the electrical current so as not to overload the power source 40. The data circuit 960 also distributes the column clock signal 734, the data signal 730 and a latch signal 966 in an appropriate sequence to all the pixel drive controls 956. It should be appreciated that the use of a column clock signal 734 having a reduced pulse rate reduces the power consumption of the system 10, while the LED stagger pulse width modulator 962 functions to equalize the power consumed by turning the LEDs 610,620,630 on and off at different times relative to each other.

In operation, the control units 550 A-B access the rectangular ping-pong memory 720 in a manner so that the most-significant bit (MSB) of the last flip-flop 932 of the horizontal shift register 940 in each column is read and shifted at a high speed rate into all of the column driver array panels 500A in row 1 of the display 14 with the high-speed clock signal 732. Referring now to FIGS. 3, 9, and 10, the configuration shown for the control units 500 A-B is 8 pixels horizontally by 3 pixels vertically. The serial bit stream is created to transfer one bit of information into flip-flop 932 and that this data is shifted horizontally across each of the control units 500A-B configured as column drivers. Therefore, the data stream is created to load the data into the most-significant bit (MSB) pixel for the top line of the display columns A, I, P, etc. . . . As such, the columns of the display 14 are indexed by eight, whereby FIG. 9 shows the shift register daisy-chain configuration of the pixel drive controls 956. When all the column driver array panels 500A have been loaded at a high speed rate, the column clock signal 734 shifts all these bits in parallel into the vertical shift register 942. Next, the control hardware accesses the next bit to be loaded into the next bit of the shift register in each shift register chain which is the most significant bit (MSB) of the red PWM intensity values of the red LEDs 610 of the upper-left pixel of every array panel in the top row of the display, i.e., columns A, I, P etc. This accessing process continues until the last bit of each eight bit shift register for each color PWM intensity for columns A, I, P etc. Next, a counter in the intensity values for the green LEDs 620 proceeds in the same manner for the next eight bits, and finally the intensity values for the blue LEDs 630 are loaded in the next eight bits. Next, a counter in the PCI driver interface 240 advances to select the pixel 600 one position to the right (i.e. columns B, J, Q, etc. . . . ), while accessing the data pertaining to all the colors of the LEDs 610-630 (columns B, J, Q etc.), to match the order that the shift registers in each display module 30 are cascaded. The process continues until all eight pixels in the top row of the control unit 500 A-B are loaded with data. Then, another counter in the PCI driver interface 240 is incremented to select the data for the pixels 600 one row below the top row (i.e. row 2) and the preceding process is repeated for all pixels in this row. The horizontal and vertical counters index to select each of the pixels 600 in each row, as noted previously at step 824, the preceding process continues until the vertical address counter is equal to the vertical dimension of the array and the horizontal address has been incremented so that it points to the maximum horizontal dimension of the display. At this point the hardware circuitry has completed loading the entire shift register chain for the entire display 14.

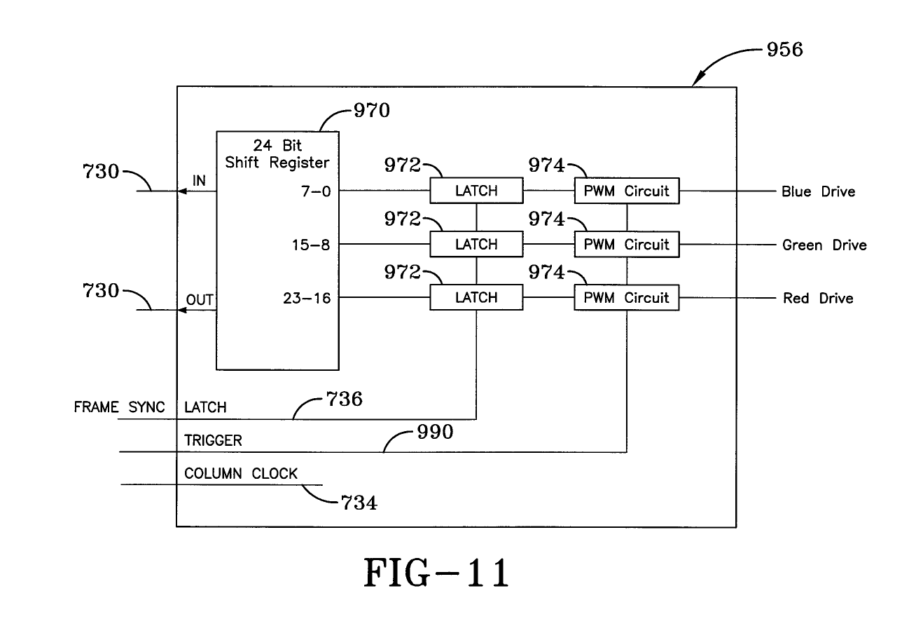

Referring now to FIG. 11 a detailed diagram of the pixel drive control is designated generally by the numeral 956. Each pixel drive control 956 includes a 24-bit shift register 970, a series of latches 972, and a series of pulse-width-modulator counter circuits 974. As can be seen, one latch 972 and one PWM circuit 974 is associated with each of the blue, red and green LEDs. When the data for the entire display 14 has been loaded, the PCI interface 240 generates a frame synchronization signal 736 at step 826, which causes the serial data contained in the display module 30 to be latched into the latch circuit 972 within the FPGA maintained by the control unit 550 which provides the appropriate count to the respective pulse-width-modulator counter circuits 974. It should be appreciated that the PWM circuit 974 is connected to a driver device that turns the current on and off through the LEDs 610,620,630. The frame sync signal 736 also synchronizes a PWM stagger circuit 962 within each data cascade 930, which generates the stagger trigger signals that trigger the PWM counter circuits 974. Each display module 30 uses this stagger PWM circuit 962 to derive its own staggered set of trigger signals 990 to better equalize the current required to drive the display 14. The column clock signal 734, which is used to shift the data vertically through all of the columns, also doubles as the source of the clock required by the PWM counter circuitry 974. The FPGA 242 of the PCI interface 240 generates the column clock signal as a free-running signal, which is synchronized, so that it occurs at the point in time when all of the column drivers 500A have been loaded with the high-speed data. This approach allows pulse-width-modulated drive signals for the LEDs 610-630 to be generated continuously, at the same time as the data for the next frame is being loaded.

The display modules 30 are designed so that the resulting display 14 is modular so that any display module may be interchanged easily to allow for routine maintenance of the display 14. The control panel 500 also contains a linear regulator to derive a regulated power for the circuitry maintained by the display module 30. Therefore, each display module 30 can tolerate large variations in the unregulated power supply inputs to each display module 30 due to line drops in the wiring which connect the entire display 14 together. The use of differential line drivers and receivers reduces susceptibility to noise either generated directly by the display or from external sources. It should be appreciated that the method of interconnecting the display modules 30 horizontally and vertically in the display 14 and using differential drivers and receivers enables reliable data transmission across the display 14. Furthermore, the display modules 30 are cascaded throughout the display 14, such that the power and ground connections are allowed to float up and down because of the required current draw for driving the LEDs 610,620,630 and the voltage drops in the wiring that interconnects the display modules 30. Since the power and ground connections are cascaded between adjacent display modules 30 across the display 14, and since each display module 30 is only connected to the preceding one in the chain, and the following one, noise induced by switching LED currents does not influence the signals from the line receivers because the common-mode rejection of the differential receivers causes the noise induced between adjacent boards to be rejected. The high-speed data transfer horizontally, and the slower data rate vertically through the array panels also results in the majority of the circuitry in the display using a slower data rate, resulting in improved reliability, and noise reduction in the design.

Therefore, one advantage of a high-resolution display is that sandwich board material is used to from display panels maintained by a display module, which significantly reduces the weight and the cost of maintaining a large-scale display. Still another advantage of the present invention is that a control panel is flexibly attached to adjacent display panels of the display module, allowing changes in the profile of the surface to which the display module is attached to be readily absorbed. Yet another advantage of the present invention is that the control panel utilizes PWM (pulse width modulation) to adjust the intensity of the pixels carried thereby based on the amount of electrical power available from a power source. Another advantage of the present invention is that a video processing system coupled to the display modules sequences the video image data to create a scrambled bit stream that matches the arrangement of the cascaded display modules.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A display module for a display comprising:
a control panel;
a pair of display panels comprising a honeycomb layer, wherein said control panel and said display panels carry a plurality of illuminable pixels; and
a communication link flexibly coupling said control panel to said pixels maintained by said display panels;
wherein said plurality of illuminable pixels are controlled by said control panel.

2. The display module of claim 1, wherein said honeycomb layer is formed of a plurality of open cell columns.

3. The display module of claim 1, wherein said open cell columns are connected.

4. The display module of claim 1, wherein said pixels are comprised of light emitting diodes (LED).

5. The display module of claim 1, wherein said control panel further comprises a power connector and a data connector to receive compatible power and data signals respectively.

6. A display to render a video image comprising:
a M-row by N-column array of display modules maintaining a plurality of illuminable pixels, wherein said array is divided into at least a first section and a second section;
a power bus having at least two power grids, such that one of said grids is coupled to said first section, and another of said grids is coupled to a second section, so as to provide independent power signals thereto; and
a video processing system coupled to each said N-column of said array, said video processing system receiving a video input data signal containing intensity values associated with each said pixel from a video input source coupled thereto;
wherein said video processing system adjusts said intensity values based on the magnitude of said power signal supplied by said power source.

7. The display of claim 6, wherein said intensity values are associated with each frame of a video image supplied by said video input data signal.

8. The display of claim 7, wherein said video processing system adjusts said intensity values for each frame of said video image.

9. The display of claim 6, wherein said display modules comprise a control panel flexibly and electrically coupled to a pair of display panels, such that said pixels carried by each said panel is controlled by a pulse width modulation (PWM) signal generated by said control panel, such that said control panel adjusts said PWM signal based on said adjusted intensity values.

10. The display of claim 6, wherein said power bus includes at least two separate power grids, such that one of said grids is coupled to the column of a first portion of said display modules and another of said grids is coupled to the column of a second portion of said display modules.

11. The display of claim 10, wherein said at least two separate power grids are configured whereby said power grids are horizontally and vertically cross-connected.

12. A display to render a video image comprising:
a M-row by N-column array of display modules maintaining a plurality of illuminable pixels, wherein said array is divided into at least a first section and a second section, wherein said display modules comprise a control panel that is flexibly and electrically coupled to a pair of display panels that include a honeycomb layer of open cell columns, such that said pixels carried by each said panel is controlled by said control panel;
a power bus coupled to said display modules to provide a power signal thereto; and
a video processing system coupled to each said control panel of said array, said video processing system receiving a video input data signal containing intensity values associated with each said pixel from a video input source coupled thereto;
wherein said video processing system adjusts said intensity values based on the magnitude of said power signal supplied by said power bus, said adjusted intensity values used by said control panels to control the illumination of said pixels.

13. The display of claim 12, wherein said intensity values are associated with each frame of a video image supplied by said video input data signal.

14. The display of claim 13, wherein said video processing system adjusts said intensity values for each frame of said video image.

15. The display of claim 12, wherein said power bus comprises at least two power grids, such that one of said grids is coupled to said first section, and another of said grids is coupled to a second section, so as to provide independent power signals thereto.

16. The display of claim 15, wherein said at least two separate power grids are horizontally and vertically cross-connected.

17. A display to render a video image comprising:
a M-row by N-column array of display modules maintaining a plurality of illuminable pixels, wherein said array is divided into at least a first section and a second section, wherein said display modules comprise a control panel that is flexibly and electrically coupled to a pair of display panels that include a honeycomb layer of open cell columns, such that said pixels carried by each said panel is controlled by said control panel;
a power bus having at least two power grids, such that one of said grids is coupled to said first section, and another of said grids is coupled to a second section, so as to provide independent power signals thereto; and
a video processing system coupled to said array via a driver interface, said video processing system adapted to receive a video input data signal containing intensity values associated with each said pixel from a video input source;
wherein said video processing system converts said video input data signal into a data word that is addressed according to the M-rows and N-columns of said array, said video processing system comprising a first and a second buffer memory that are coupled to said driver interface that converts said data word into a serial data interface signal to control the illumination of said pixels maintained by each said display module, such that said video processing system loads said data word into said first buffer memory when said second buffer memory is loading another said data word into said driver interface, and loads said data word into said second buffer memory when said first buffer memory is loading another data word into said driver interface.

18. The display of claim 17, wherein said pixels maintained by each said display module are coupled to respective pixel drive controls arranged in series in a M-row by N-column array, wherein each end of the series is defined by an input and an output.

19. The display of claim 18, wherein each said array of pixel drive controls maintained by each said display module are coupled together along each N-column, wherein said output drive control of one display module is coupled to said input drive control of another display module.

20. The display of claim 19, wherein said serial data interface signal comprises successive serial data bits that are associated with a first video pixel to be respectively loaded into each input of said pixel drive control of each said display module, wherein serial data bits associated with subsequent video pixels shifts said first pixel into said adjacent pixel drive controls.
